(19) United States
(12) Patent Application Publication
(10) Pub. No.: US 2010/0034514 A1
(43) Pub. Date: Feb. 11, 2010

(54) DISPLAY DEVICE AND METHOD WITH CONTENT RECORDING AND/OR STREAMING

(76) Inventor: Mathieu Paul Luc Massart, Gent (BE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/186,236

(22) Filed: Aug. 5, 2008

(51) Int. Cl. H04N 5/91; G09G 5/12

(52) U.S. Cl. 386/95; 345/1.1; 386/E05.003

(57) ABSTRACT

A content recording and display device, system and method that is operable to display content placed in a frame buffer, and further to stream out and/or record the content placed in the frame buffer for remote viewing or later playback.

### FIELD OF INVENTION

The present invention relates generally to display systems and more particularly to a display device and method that streams the content that actually was shown on the imaging device of the display device for display on another display device or devices and/or for storage for later playback through the device or some other display device or devices.

### BACKGROUND

Conventional image acquisition and display systems typically comprise one or more input devices such as cameras, video recorders, PCs, etc. that provide respective image information, typically in the form of a data stream, to a display device, such as a monitor, for display on the imaging device of the monitor. By way of a specific example, a security monitoring system may have one or more surveillance cameras streaming image data to a central monitoring system which processes the data streams and displays the content on one or more monitors. The data streams may be, for example, in the JPEG2000 format, MPEG format, analog or digital sources such as video, RGB, DVI, HDMI. Other content may also be displayed such as content that it is created by the display itself, in particular on screen displays such as menus.

Heretofore a need has existed to record and playback content that was shown on a display. This may be done, for example, to verify a claim by a security guard that he did not see something that purportedly happened within the view of a security camera or cameras, or to reenact some event exactly as shown on a display.

In a typical content recording and playback system, a data stream from one or more input devices would be recorded upstream of the input electronics of a monitor that processes the data streams for display on the imaging device (LCD panel, CRT, etc.) of display device. During playback, the recorded data streams would be processed and displayed on a monitor or monitors.

### SUMMARY OF THE INVENTION

The present invention provides a content recording and playback system and method that overcomes one or more drawbacks associated with previously known content recording and playback systems.

One problem with the previously known systems, where content is recorded before the display device containing input electronics, a frame buffer or buffers and an imaging device such as an LCD panel, CRT, etc., is the lack of assurance that the content will be recorded or played back exactly as it was originally displayed. For instance, the wrong content could have been recorded, the cabling connecting an input device to the display device could have failed, the input device itself could have failed, etc.

In accordance with the present invention, the content is recorded at the time, and more particularly after, the content is received in the frame buffer used by the display device to display the content on one or more imaging devices of the display device. Consequently, the content will be properly recorded no matter what the source of the content was, nor would it matter what type of display on which the content was being displayed. The content in the frame buffer may additionally or alternatively be streamed out to another display device or devices for remote viewing. Having content that is properly recorded and/or streamed out assures a level of accuracy that is important for industries such as the broadcast industry and security industry.

The content can be played back or reconstructed through the device or through another device or devices.

Accordingly, the invention provides a display device comprising one or more inputs for receiving content from respective input devices, a display processor for processing the content received at the one or more inputs and placing video image data in one or more frame buffers for use by one or more imaging devices for displaying the content, and a stream output for streaming the video image data for storage and/or display on another display device.

The display device may further include one or more of the following features:

the display processor includes a composer configured to mix content from the one or more inputs and provide to the one or more frame buffers video image data including the mixed content.

an internal storage or an external storage connected to the stream output for storage of the video image data, which may include for example plural screen shots taken of the content in the one or more frame buffers.

meta data is added to the video image data in the frame buffer or buffers for streaming and/or storage with the video image data.

the meta data added includes one or more of a timestamp, operating status of the display device, or input status.

a sensor input for receiving a signal from a sensor that senses a parameter relevant to the video image data being streamed from the frame buffer or buffers, and wherein the meta data includes data representative of the signal received from the sensor.

the sensor input is configured to receive a signal indicative of one or more of lamp voltage, lamp brightness, or status of an image on the one or more imaging devices.

the meta data is analyzed inside the display device.

the content recording and display device is configured to playback stored video image data through the one or more frame buffers.

The one or more imaging devices, such as LCD panels, CRTs, etc., may be arranged to form an array of video imaging devices.

Moreover, the invention provides a display system comprising the display device and an external storage and/or other display device to which video image data from the one or more frame buffers is supplied for storage and/or display. The system may further comprise the one or more input devices connected to the one or more inputs of the content recording and display device.

In addition, the invention provides a method of streaming content displayed on one or more imaging devices of an display device, comprising receiving content from one or more input devices, processing the content received from the one or more input devices and placing video image data in one or more frame buffers for use by one or more imaging devices for displaying the content, and streaming the video image data to a storage and/or another display device.

The method may further include one or more of the following features:

a composer is used to mix content from the one or more input electronics and place in the one or more frame buffers video image data including the mixed content.

meta data is added to the content in the frame buffer or buffers for streaming and/or storage with the video image data.

the meta data added includes one or more of a timestamp, operating status of the display device, or input status.

using a sensor to sense a parameter relevant to the image data being streamed from the frame buffer or buffers, and wherein the meta data includes data representative of the signal received from the sensor.

the sensor senses one or more of lamp voltage, lamp brightness, or status of an image on the imaging device or devices.

According to another aspect of the invention, a content playback method for image recognition comprising receiving content in one or more frame buffers of a display device from one or more inputs, recording the content, searching the recorded content for features, and streaming out the content from the frame buffer. This method may further comprise monitoring the streaming content from the frame buffer for pre-specified events.

The foregoing and other features of the invention are hereinafter described in greater detail with reference to the accompanying drawings.

### BRIEF DESCRIPTION OF THE DRAWINGS

In the annexed drawings:

FIG. 1 is a diagrammatic illustration of an exemplary content recording and/or streaming display system according to the invention;

FIG. 2 is a diagrammatic illustration of an array of display devices being synchronized; and

FIG. 3 is screenshot of replayed recorded content.

### DETAILED DESCRIPTION

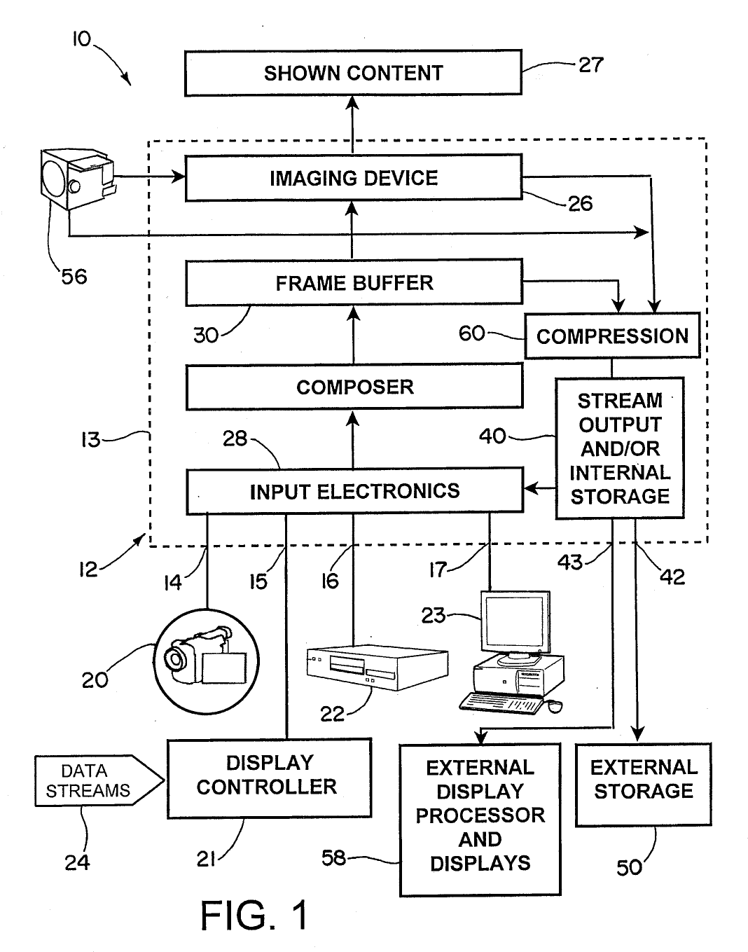

Referring now in detail to the drawings and initially to FIG. 1, an exemplary content recording and/or streaming system according to the invention is indicated generally at 10. The system 10 generally comprises a display device 12 framed in broken lines that also depict the housing 13 of the display device. The device 12 has one or more inputs (four indicated at 14-17) for receiving content from respective input devices, such as a video camera 20, a display controller 21, video recorder 22 and/or personal computer 23. The display controller 21 may in turn receive one or more data streams as depicted at 24 (for example, a display controller in a security system may receive a large number of data streams from the system's cameras). The system may have any number of different types of input devices for supplying content to the device 12 for display on one or more imaging devices 26 with the shown content being represented by the box 27 labeled “SHOWN CONTENT”. The input streams may include streaming media (MPEG/JPEG/ . . . ).

The display device 12, which may be in the form of a monitor, projector, LCD display, plasma display, etc. (and may be front or rear projection, or otherwise), comprises input electronics 28 including a display processor for processing the content received at the input(s) 14-17 and placing image data in one or more frame buffers 30 for displaying the content on the one or more imaging devices 26. The imaging devices may be of any desired type that creates the image pixels or displayed image, such as an LCD panel, DLP chip, CRT, LED panel, plasma panel, OLED or OLED wall, LED or LED wall, video wall, etc. The imaging device or devices may be physically located within the housing of the device 12.

As thus far described, the device 12 and the balance of the system 10 may be of a conventional design. The input electronics 28 may include electronic circuitry and program logic for receiving and processing the content supplied to the one or more inputs 14-17 to produce therefrom video image data placed in the one or more frame buffers 30. The imaging device or devices access the one or more frame buffers to produce the shown content 27. In a multi-display system, plural imaging and/or display devices may be arranged in an array and the images synchronized in a well known manner. For example, a tiled video wall may have multiple projectors in an array (thus display device). Each of the projectors may have one or more imaging devices. A projector, for instance, may have three imaging devices, i.e. three small LCD panels for red, green and blue.

The device 12, if desired, may further comprise a composer 36. The composer receives the content from the one or more inputs 14-17, and is operative to mix the content from the input signals receive from the input devices or other input signal, and process the mixed signals to form the video image data placed in the frame buffer or buffers 30.

As the system components thus far described are known in the art, further details need be provided for the sake of brevity.

In accordance with the present invention, the video image data that is placed in the one or more frame buffers 30 is streamed at 40 to an internal storage or via outputs 42 and 43 to an external storage 50 or other display device or devices 58. The internal storage or external storage 50 may be any suitable data storage device including, by example and not by way of limitation, random access memory (RAM), one or more mass storage devices such as optical discs, magnetic storage hard disks, magnetic tape, optical table, flash memory, etc. The storage may be local or remote. In the latter case, the storage of the display device is the output 42 for transmitting the video image data to the remotely located storage 52 separate from the device 12.

The video image data in the frame buffer or buffers 30 may be streamed out to the internal or external storage 50. The data stream(s) may be in the JPEG2000 format, MPEG format, or another format. The streamed content can be lossless or lossy, and compressed or not compressed, as by compression circuitry and/or logic depicted by box 60, all in a conventional manner.

The content recorded in the storage 50 (external and/or internal) can also be native or scaled, for instance as a thumbnail. The recorded content can be used for analysis for image recognition, for looking up text or alarms, for relating to time, etc. The recorded content can be the content shown in real time, regardless of the failing of the content creation device, cabling, or input electronics. If a cable is cut or unplugged, the content (actually absence thereof—there would be no image and the display would simply being showing a blank screen) will still be preserved. Likewise, if the wrong input is shown on the imaging device, the recording of the video image data in the frame buffer will preserve the wrong image content.

The video image data from the frame buffer or buffers 30 may have added thereto for storage (recording) in the storage 50 (external and/or internal) meta data from a source 56 of such data, which source may be part of the device or a component attached to the device through a suitable I/O interface. The meta data can include, but is not limited to, a timestamp, brightness information to log that the lamp or backlight of an imaging device 26 was on during recording, status of the display device 12 (used to determine if the display device is working properly), other input data that could be used for analysis of the content at a later time, or to determine if there was a signal present on the input side, etc. The meta data can also be sensor based, for example, lamp voltage or for brightness. The meta data can further be combined with real read-back of an image to confirm if there is an image at all. For instance, a sensor (such as a camera) may be positioned externally to view what is actually displayed on the screen so at to provide information as to whether or not there is content being displayed. The sensor provides an output that can be recorded with indicates whether or not a viewable image exists on the screen while the recorded content tells what is in the image.

The meta data may alternatively be analyzed inside the device, for example, to determine whether or not to record the content in the storage 50. An example of this process would be if frames N+1 were not equal to frame N. then the content would be recorded. This could be used for purposes such as intrusion detection. Consider for example a secured area with a camera. Normally the camera will always give the exact same image (except for some noise). The moment an intruder enters the area, the camera shows a substantially different image. This can trigger an alarm: start recording now.

The device 12 preferably is equipped to playback the recorded “shown content” from the storage 50 (internal or external). The stored image data may be streamed back to the input electronics as the only input for passage to the frame buffer and display on the imaging device or devices 26. The shown content 18 can be displayed with the same resolution or a scaled resolution, and/or can be shown in different formats.

As will be appreciated, the recorded content will be exactly what was displayed in the first instance. If the cable for an input device were not connected properly for example resulting in no feed from such input device, the originally displayed data would not include the feed from such input device and consequently the redisplayed recorded images would be lacking such input as well.

The device 12 or system 10 may further be configured with software and/or hardware components that can search for features in the recorded video image data. The recorded content can be searched, for example, for features such as text, video, alarm, image quality, motion, etc. The content can be monitored for certain events such as image loss, alarms, motion, etc. This allows what was shown on the display to be reconstructed and linked to operator actions. Consider, for example, a very long recording of days of traffic and you need to find when a car had passed with license place JB 007. Conventional smart detection algorithms can be used to search for this instead of having to replay days and days of recorded traffic.

The recorded video image data can also and/or alternatively be displayed on another display device or devices 58. The other display devices 58 can be any type including but not limited to, a rear or front projector, an LCD or plasma display, an OLED or OLED wall, an LED or LED wall, and a video wall (and may be front or rear projection, or otherwise). The recorded content can be played on different displays with the same resolution or a scaled resolution, and can be shown in different formats.

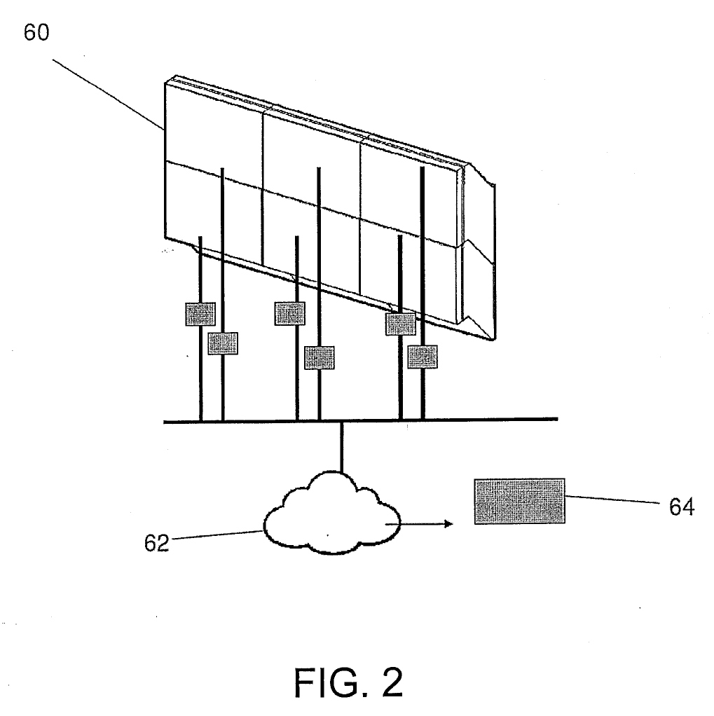

In FIG. 2 a video wall consisting of an array of display cubes 60 each including a rear projector (display device). Each of the display devices in this example streams out it's own content, such as to a network. However to see the full content of the video wall on a PC (personal computer/microprocessor device), each of these streams can be scaled down and combined to a single image (there being six sub-images in this example).

A screen shot can be taken at various locations and times in the device 12. A screen shot can be taken as the content is received by the frame buffer 30, as the streamed out content leaves the frame buffer, after the content has been received by the imaging device 26, etc. It does not matter where in the content playback device a screen shot is taken, nor does it matter what time the screen shot is taken. Furthermore, the device is not limited to taking only one screen shot. The screen shot(s) can be taken in any format, and can be used for, but are not limited to being used for analysis purposes. The use of screen shots provides a reduced sub-case of content recording. It may be that now and then one wants to see the image content (as when a lot of content is nearly static). Also, in some cases the display device may have a very basic built-in recorder where technical reasons limit it to providing a screen shot every 5 seconds for instance instead of a steady stream, or maybe the network is limiting.

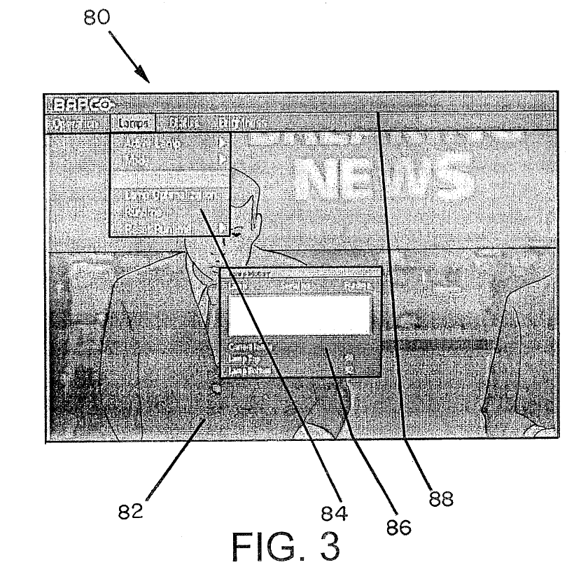

FIG. 3 shows actual played back content. As shown, the illustrated screen shot 80 shows image content 82 from a camera and also on screen display content 84, 86, 88 that overlies the content 82. This is exactly the same image that originally appeared on the screen. Consequently, operator actions are revealed by the on screen display content (the pull-down menus).

In summary, the invention enables the recording (or streaming) from the frame buffer. In essence, a “legal recording” is obtained to assure that one can replay exactly what is being shown on the imaging device or devices 26, independent of defects on the input side or content distribution system. Meta data can be added to give extra system status e.g. was the lamp burning? Time stamping can be used for reconstructing events over time.

Although the invention has been shown and described with respect to a certain preferred embodiment or embodiments, it is obvious that equivalent alterations and modifications will occur to others skilled in the art upon the reading and understanding of this specification and the drawings. In particular, in regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent). In addition, while a particular feature of the invention may have been described above with respect to only one or more of several illustrated embodiments, such feature may be combined with one or more other features of the other embodiments, as may be desired and advantageous for any given or particular application.

1. A display device comprising one or more inputs for receiving content from respective input devices, a display processor for processing the content received at the one or more inputs and placing video image data in one or more frame buffers for use by one or more imaging devices for displaying the content, and a storage and/or output for outputting the video image data for storage and/or display on another display device.

2. A display device according to claim 1, wherein the display processor includes a composer configured to mix content received at the one or more inputs and provide to the one or more frame buffers video image data including the mixed content.

3. A display device according to claim 1, wherein the video image data stored in the storage includes plural screen shots taken of the content in the one or more frame buffers.

4. A display device according to claim 1, wherein meta data is added to the content in the frame buffer for streaming and/or storage with the video image data.

5. A display device according to claim 4, wherein the meta data added includes one or more of a timestamp, operating status of the display device, or input status.

6. A display device according to claim 4, comprising a sensor input for receiving a signal from a sensor that senses a parameter relevant to the image data being stored in the storage, and wherein the meta data includes data representative of the signal received from the sensor.

7. A display device according to claim 6, wherein sensor input is configured to receive a signal indicative of one or more of lamp voltage, lamp brightness, or status of an image on the one or more imaging devices.

8. A display device according to claim 4, wherein the meta data is analyzed inside the display device.

9. A display device according to claim 1, in the form of a rear or front projector, an LCD or plasma display, an OLED or OLED wall, an LED or LED wall, or a video wall.

10. A display device according to any preceding claim 1, comprising an output by which the video image data can be supplied for display on one or more other display devices.

11. A display device according to claim 1, wherein the display device is configured to playback the stored video image data through the one or more frame buffers.

12. A display device according to claim 1, wherein the one or more video monitors are arranged to form an array of video monitors.

13. A display system comprising a display device according to claim 1, one or more input devices connected to the one or more inputs of the content recording and display device.

14. A display system according to claim 13, wherein the one or more input devices include a display controller that has inputs for receiving multiple data streams.

15. A method of streaming and/or recording content displayed on one or more imaging devices, comprising receiving content from one or more input devices, processing the content received from the one or more input devices and placing video image data in one or more frame buffers for use by one or more imaging devices for displaying the content, and storing and/or outputting the video image data for storage and/or display on another display device.

16. A method according to claim 15, wherein a composer is used to mix content received at the one or more inputs and provide to the one or more frame buffers video image data including the mixed content.

17. A method according to claim 15, wherein meta data is added to the content in the frame buffer for streaming and/or storage with the video image data.

18. A method according to claim 17, wherein the meta data added includes one or more of a timestamp, operating status of the display device, or input status.

19. A method according to claim 17, comprising using a sensor to sense a parameter relevant to the image data being stored in the storage, and wherein the meta data includes data representative of the signal received from the sensor.

20. A method according to claim 19, wherein sensor senses one or more of lamp voltage, lamp brightness, or status of an image on a display.

21. A content playback method for image recognition comprising receiving content in a frame buffer, recording the content, searching the recorded content for features, and streaming out the content from the frame buffer.

22. A content playback method according to claim 21, comprising monitoring the streaming content from the frame buffer for events.
